(19) United States
(12) Patent Application Publication
(10) Pub. No.: US 2003/0117583 A1
(43) Pub. Date: Jun. 26, 2003

(54) Device for displacing 3-dimensional objects in the projection space of a projection system

(76) Inventor: Peter Werhahn-Wunderlich, Berlin (DE)

Correspondence Address: HARNESS, DICKEY & PIERCE, P.L.C., P.O. BOX 8910, RESTON, VA, 20195, US

(21) Appl. No.: 10/019,553

(22) PCT Filed: Dec. 21, 2001
(86) PCT No.: PCT/EP99/04422

(51) Int. Cl. G03B 21/32

(52) U.S. Cl. 352/88

(57) ABSTRACT

A device for moving 3-dimensional objects in a projection space of a projection system is disclosed. The device includes a rotating device and a moving belt countersunk in the rotating disk. The rotating disk and/or the moving belt have sensors for detecting movement of an object on the rotating disk and/or the moving belt, and the moving belt and/or the rotating disk are driven with the help of a control/regulation device as a function of a detected movement of the object.

This invention relates to a device for moving 3-dimensional objects in the projection space of a projection system having a rotating disk and a system for the presentation of live shows that are combined with and/or superimposed on projected images and/or cinema films, having a projection space, at least two projection systems, a first and a second projection system and at least one projection surface which is introduced into the projection space and can be removed from it or is arranged in a stationary mount in the projection space, said system having a device for moving 3-dimensional objects.

Systems for the presentation of live shows that can be combined with and/or superimposed on projected images and/or films are known from the related art publications cited below:

1. European Patent 427 864 A1

2. International Patent WO 95/33540

3. International Patent WO 91/12864

European Patent 427 864 A1 discloses a cinema concert hall having a common projecting screen, side projecting screens, a top projecting screen and a stage floor. The upper projecting screen sits on an axle and can be rotated about it, so that in the horizontal position, it forms a roof over the common projecting screen, and in the vertical position, it forms an additional surface for the common projecting screen. Each side image surface has a vertical axis about which it can be rotated, forming side projecting scenes in one position but forming a continuation of the common projecting screen in the other position. Through such a construction, the projected information is greatly enlarged, and the perception of the same by the viewer is brought closer to an illusory reality.

Although images or movies projected through the cinema concert hall according to European Patent 427 864 A1 may be closer to reality than has been possible through reproductions in the past, it is impossible with these systems to combine and superimpose projected images with an actor acting on the stage as part of a live show, to thereby obtain a perfect 3-dimensional representation of the event.

International Patent 95/33540 discloses a presentation structure for the presentation of a show consisting of live shows combined and superimposed with projected images, comprising a projector and a beam splitter, which can be manufactured either of glass or a flexible film. The projector makes available a moving or stationary image that is combined with the live show on the stage. The beam splitter may be advanced forward and retracted, for example, to provide visual effects.

A disadvantage of the system according to International Patent 95/33540 is that the movie screen is only a movable decorative background for the stage event and does not in any way dialogue and correspond to same. In particular, the international patent cited above does not give any basis for indicating how one must proceed to combine movements on the stage with the speed of the moving image and to move actors or objects from the movie screen onto the stage and from the stage back into the film in a manner that is almost inexplicable for the viewer.

International Patent 91/12864 discloses a device for 3-dimensional representation of objects in a theater, a circus or a concert hall, using front projection and rear projection onto a stationary movie screen.

A disadvantage of the system according to International Patent 91/12864 is that the images are projected onto a stationary projection screen and the means for projection are also stationary.

The system according to International Patent 91/12864 thus does not allow presenters to move from a projected background into the projection space or the stage space or to act in front of a projected virtual image.

The object of this invention is to avoid the disadvantages mentioned above and to provide a device with which 3-dimensional objects can be moved in the projection space of a projection system in front of a projected image in such a way that the viewer cannot perceive that the object is being moved against a projected background.

According to this invention, this object is achieved by the fact that the rotating disk and/or the moving belt includes sensors for detecting the movement of the object on the rotating disk or the moving belt and, depending on the movement of the object thus detected, the moving belt and/or the rotating disk is driven with the help of a control and regulating device. This device is preferably used in the area of the stage and theater, i.e., the object moving in three dimensions will usually be a person acting on a stage.

In a first embodiment of this invention, the moving belt and/or the rotating disk includes supporting rollers on which sensors are arranged.

It is advantageously provided that the sensors detect the weight, which changes as the person moves.

In an advantageous embodiment of this invention, the moving belt comprises a driving roller and a tension roller. In an advantageous manner, the control and/or regulating device will control the moving belt in such a way that in the case when the person moves in the direction of the driving roller, i.e., forward, the speed of the moving belt is increased, and when the person moves in the direction of the tension roller, i.e., toward the rear, the speed of the moving belt is reduced. To be able to coordinate or harmonize not only translatory movements of the presenters acting on the stage with the projected images, this invention provides that when the person moves out of the center of the moving belt toward the edge, the control device starts the rotating disk to rotate in the opposite direction.

In addition to the device for moving 3-dimensional objects in the projection space of a projection system, this invention makes available a system for the presentation of live shows which includes at least one projection surface, a projection system for virtual images and a rear projection system as well as a device for moving 3-dimensional objects with a moving belt and a rotating disk.

The projection system for virtual images advantageously has means for producing a virtual image in the projection space.

In an especially preferred embodiment of the projection system, the projection surface(s) for rear projection with the respective rear projection system(s) can be moved smoothly in the projection space so that the focus need not be altered.

Through such an embodiment, the holographic space can be increased and decreased and in addition, with the projection screen moved completely to the front edge of the projection space, it is possible for a virtual mirror image of the projection system for virtual images to be transferred from the rear projection without the viewer being able to ascertain any spatial change.

In an advanced embodiment of this invention, the means for producing a virtual image are pivotably mounted in the projection space so that any desired angle in the range of 0≦α<90° can be adjusted with respect to the horizontal. This permits an accurate adjustment of the means for producing a virtual image, e.g., when using a partially transparent film with a frame; in addition, a virtual image can be created and then removed again continuously in the stage space by pivoting without the presenter having to enter into the projection space or the stage space through the projection wall, as described in International Patent 91/12864, for example, or having to remove the projection wall.

It is preferable if the film, which is at least partially transparent, is clamped on the edges with the help of a clamping plate.

In this patent application, the term front projection is understood to refer to projection from the direction of the viewer, and rear projection is understood to refer to projection from a direction opposite that of the viewer or observer, regardless of whether projection is from the side at a certain angle. In a first embodiment of this invention, digital projection systems such as laser projection systems are preferably used. Such projection systems are characterized by a high quality of image reproduction and easy controllability.

In addition to films, glass panels may also be used as means for producing virtual images.

It is especially preferable if the system has several projection systems having means for producing virtual images. Such an arrangement permits a change in scenes which can hardly be noticed by the viewer in that, for example, the first device for producing virtual images is pivoted so that no image is projected into the stage space or the projection space while another image is projected into the viewing space by a second projection system for producing virtual images.

To allow actors or objects to move from the movie screen onto the stage and from the movie screen back into the film or the image in a manner that is largely untraceable, it is advantageously provided that the projection space includes several projection surfaces.

Depending on the spatial relationships, these projection surfaces may be completely transparent, completely reflective or mirrorized, partially transparent, partially reflective or partially mirrorized.

Especially easy movability of the projection surfaces or simple introduction into the projection space and removal out of the projection space are possible when the projection surfaces are preferably designed as movie screens. The movie screens may be made of projection film, tulle or a covering material. As an alternative, it is also possible to use a flowing oil curtain, which can be created through the use of a suitable device. Images are projected onto the same from the front. The oil curtain thus makes it easy for actors and objects to pass through the screen.

It is especially advantageous if a lighting system for lighting the stage is arranged next to the projection system in the projection space to support the appearance of actors or objects on the stage through appropriate lighting of them on the stage. The lighting system is preferably controlled in such a way that the projection onto the projection surface is not affected.

This invention is described in greater detail below on the basis of the drawings as examples.

They show:

FIG. 1: a top view of a device according to this invention for moving 3-dimensional objects;

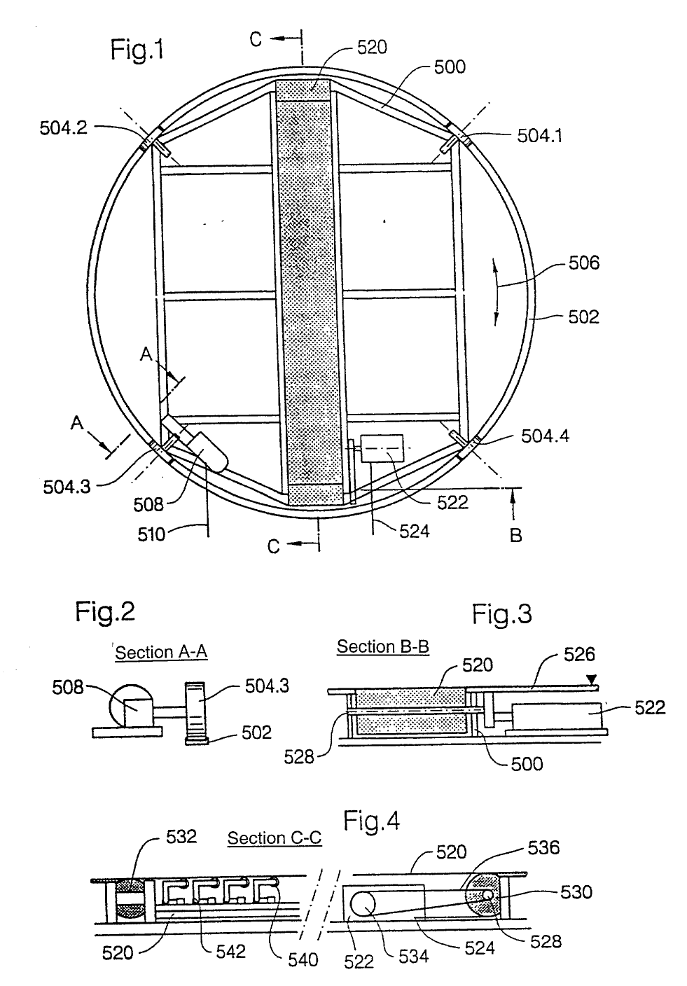

FIG. 2: section A-A from FIG. 1;

FIG. 3: section B-B from FIG. 1;

FIG. 4: section C-C from FIG. 1;

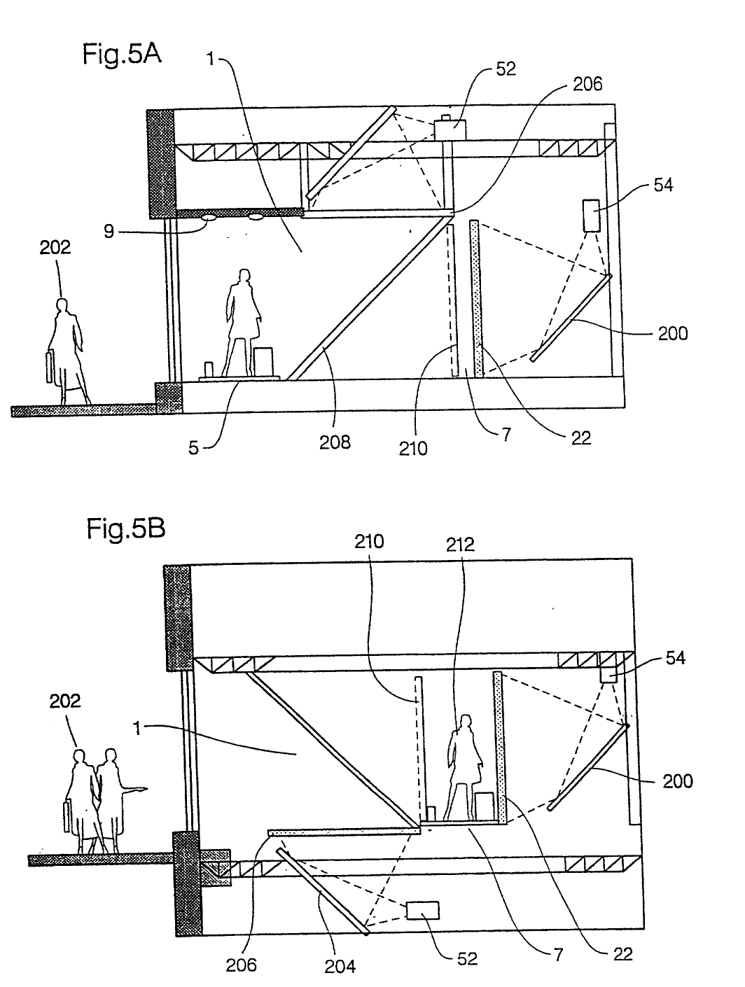

FIGS. 5A-5B: side view of first embodiment of a projection system with the device according to this invention;

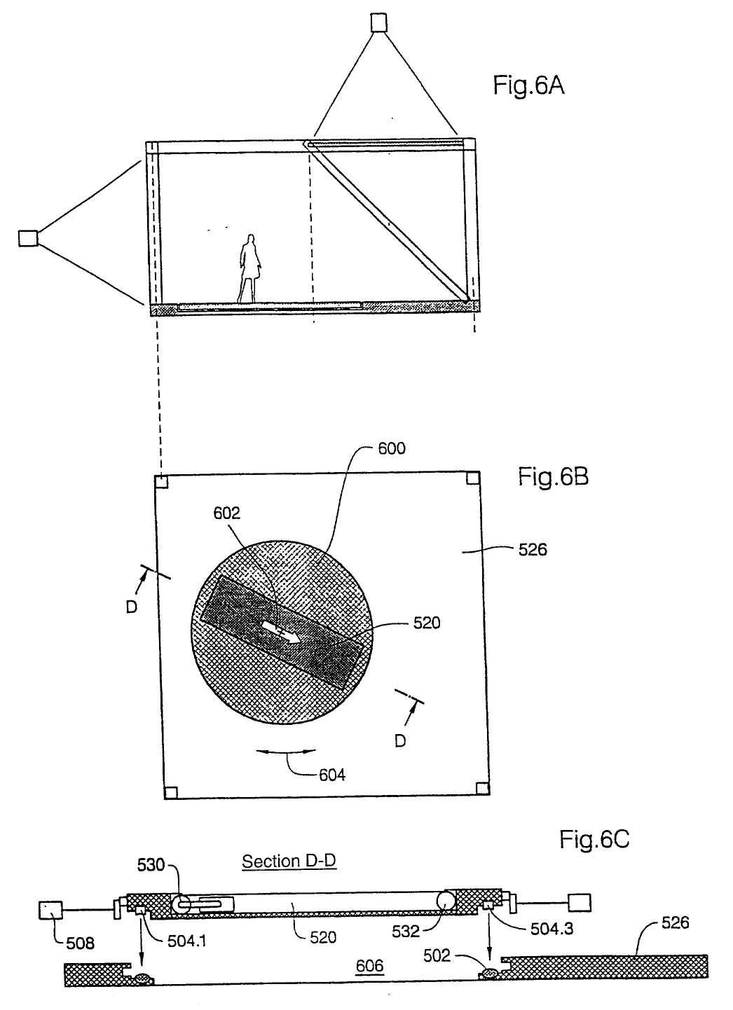

FIGS. 6A-6C: side view of a second embodiment of a projection system with the device according to this invention;

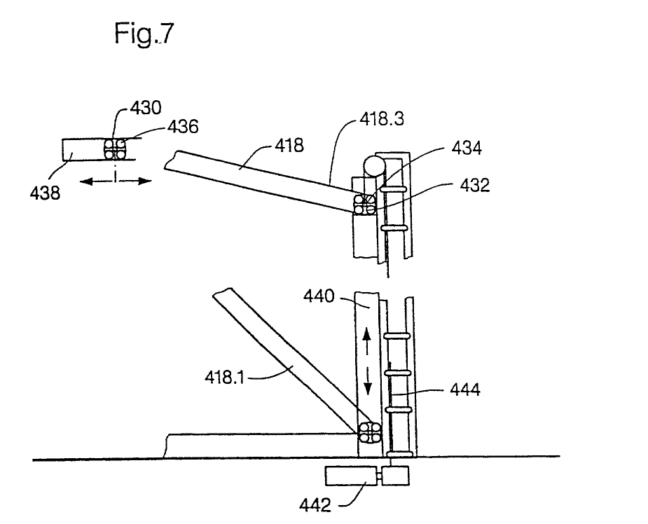

FIG. 7: detail of the pivoting device for the means for producing virtual images;

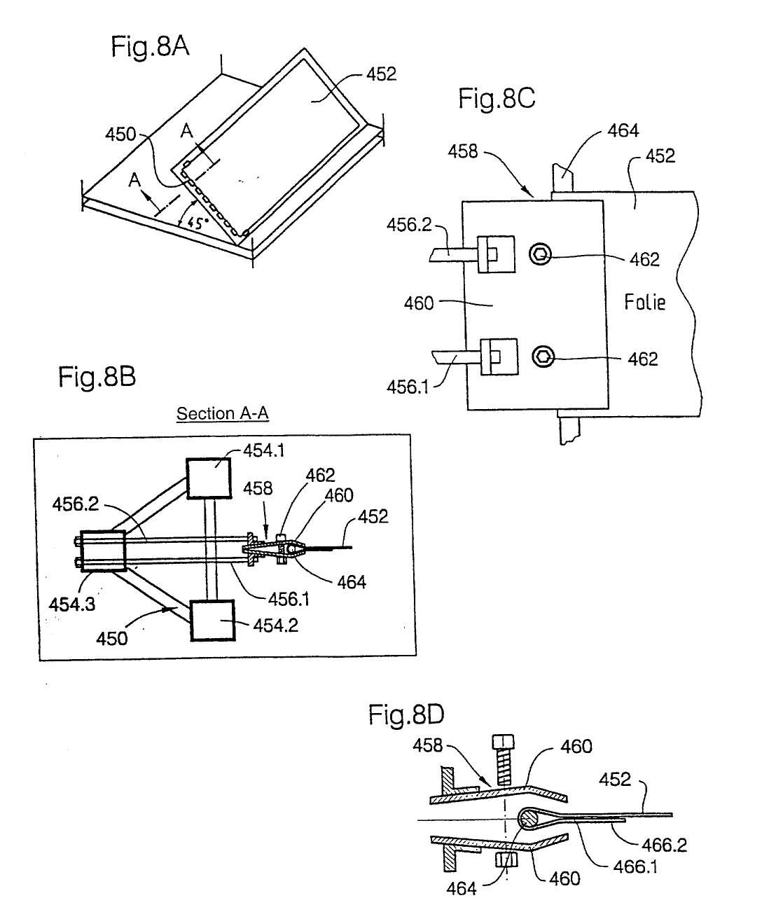

FIGS. 8A-8D: detail of an embodiment of the means for producing virtual images with at least one partially transparent film and a frame construction;

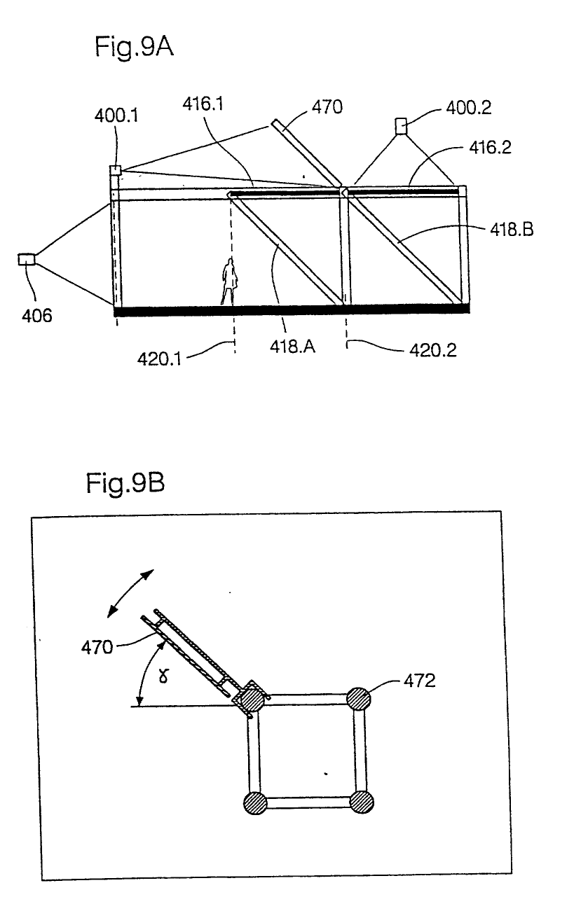

FIG. 9A: embodiment of this invention with several front projection systems;

FIG. 9B: adjustable mirrors for a projection system for producing virtual images;

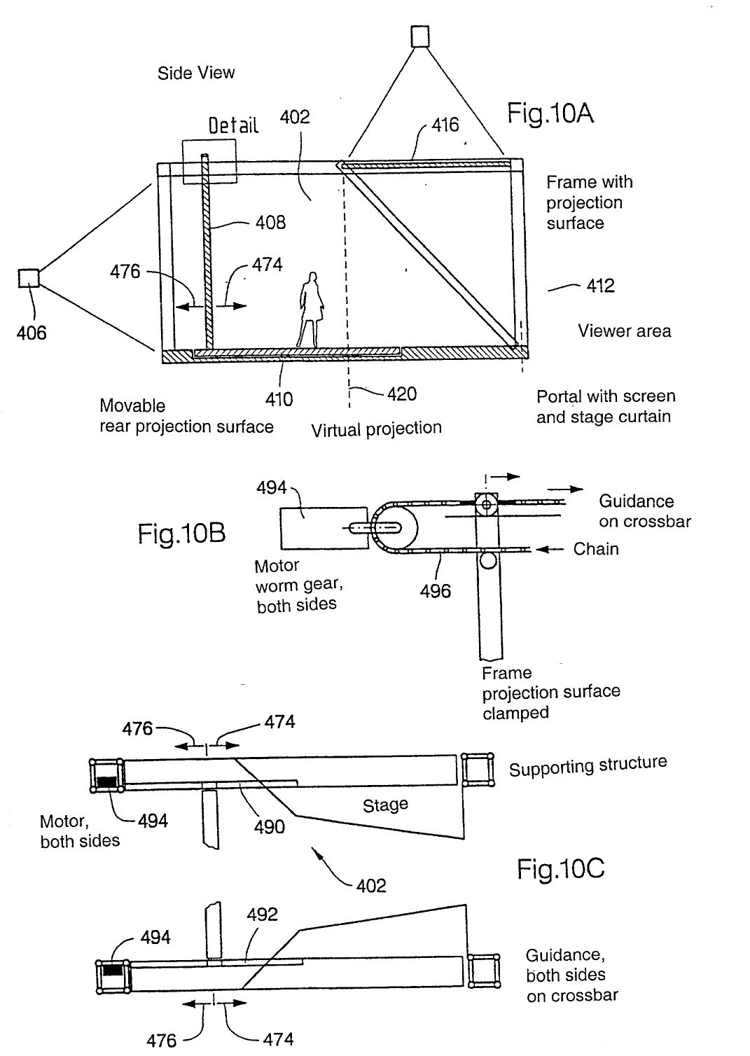

FIGS. 10A-10C: a second embodiment of the projection system according to this invention.

FIG. 1 shows in a top view a device according to this invention, which is designed as a rotating disk and has a moving belt countersunk in the middle.

The stage floor (not shown here) of the rotating disk is supported by a frame construction 500 which in turn can be rotated along a circular guide rail 502 on a total of four running wheels 504.1, 504.2, 504.3, 504.4 in the direction of arrow 506.

The drive for the rotational movement with the rotating disk mounted on the frame 500 may be electric, e.g., by means of an electric motor 508 arranged on the roller 504.3.

The electric motor 508 may in turn be connected over a control line 510 to a control/regulating device that controls the motor 510 as a function of the movement of an object or a presenter on the moving belt 520.

Preferably when the presenter moves out of the middle of the moving belt 520, e.g., to the right or left, this movement is sensed, relayed to the control device, and the control device then controls the motor 508 on the basis of this signal over line 510, so that it causes the disk to rotate in the opposite direction from the movement of the presenter.

The drive of the moving belt 520 is provided by an electric motor 542 and a driving roller (not shown in FIG. 1). The electric motor 522 may also be connected over lines 524 to the control/regulating device (not shown here). If a movement of the presenter is sensed on the moving belt, the moving belt moves in the opposite direction through control by electric motor 522. The faster the presenter moves on the moving belt, the faster is the movement in the opposite direction.

FIG. 2 shows a section A-A through the top view in FIG. 1. The roller 504.3, which is driven by electric motor 508 and is guided in the rail 502, can clearly be seen.

FIG. 3 shows a section along line B-B in the top view according to FIG. 1. This shows clearly the frame part 500 in which the moving belt 520 is countersunk. The frame 500 supports the cover 526 on which the presenter can move on the stage outside the moving belt 520. The moving belt 520 is driven by a driving wheel around which the moving belt is wrapped, and is in turn connected to electric motor 522 by a shaft 528 and a belt drive, which is shown in greater detail in FIG. 4.

FIG. 4 shows a section along line C-C in the top view in FIG. 1. This shows clearly the driving roller 530 for the moving belt and the tension roller 532. The moving belt 520 is wrapped around the driving roller 530 and the tension roller 532. The drive of the moving belt is accomplished through electric motor 522, which drives the shaft 528 on which the driving wheel 536 sits, by way of driving roller 534 and belt drive 536. FIG. 4 shows clearly that the supporting rollers 540 are arranged beneath the moving belt 520, which is arranged in the floor 526 of the stage. The supporting rollers 540 have a dual function. First, they prevent any great sagging of the belt 520 under load, and secondly, the supporting rollers are suspended by means of the lever shown here, for example, so that the weight of a presenter on the supporting belt can be sensed with a very high sensitivity. The supporting rollers thus serve as sensors for the control/regulating device for controlling and regulating the moving belt.

For example, if the presenter moves on the belt in the direction of driving roller 530, i.e., forward, this is sensed by the supporting rollers and the lever device 542 connected to them, and the speed of revolution of the belt is increased by relaying this sensed signal to the central/regulating device. When the presenter moves in the direction of the supporting roller 532, exactly the opposite occurs, i.e., the speed of the moving belt is reduced. After the presenter/actor steps on or passes a certain point, which may be marked by a roller, the moving belt comes completely to a standstill in one particular embodiment of this invention.

Due to the sensing and the control of the moving belt as explained previously, it is possible to synchronize the movement of the presenter exactly with projected images, for example.

As explained above, the suspension of the supporting rollers 540 is preferably provided by a lever device that deflects the pressure onto the supporting rollers and increases the contact travel. The response of the supporting rollers and thus the sensing can be adjusted to the corresponding body weight of the presenter with the help of a backpressure spring.

In addition to sensing the movement in the direction of the driving roller or away from it, the supporting rollers are also capable of sensing lateral movements on the moving belt, relaying this information to the control/regulating device and thus driving the motors 508 to rotate the rotating disk.

FIGS. 5A and 5B illustrate a first embodiment of a projection system in which a moving belt and rotating device is provided as described previously.

In FIG. 5A as in FIG. 5B a projector 54 for rear projection is arranged in such a way that the images are projected downward and deflected by means of mirror 200. The image is imaged on the projection surface 22, which in the present case is designed as a film, opposite the direction of the observer 202. In the present case, the projection surface is in a stationary position in the projection space.

The projection system 1 for producing virtual images may either be arranged above the projection space 1 or beneath it. In the present case, in the terminology of this patent application, it is designed as a projection system for producing virtual images. The image projected by the projection system 52 is deflected over mirrors 204, and in the present embodiment, the image passes through the transparent film 206 only in the direction of projection space 1 into the stage space. The stationary glass panel 208, which is introduced into the stage space and is arranged at an angle of 45° in the present embodiment, is very important here. A virtual image is formed through and behind the glass plate 208 and in front of the projection surface. Instead of the glass plate, a partially transparent film may also be used. Special effects can be achieved with films and glasses whose optical properties with regard to reflection and transmission may be altered by electro-optical or thermo-optical means. For example, the virtual image may be made to disappear completely at a transmission of zero.

Instead of installing the film or disk at an angle of 45°, other installation angles are also conceivable.

Through such an arrangement, it is also possible to produce virtual images that are suspended in space in front of a moving or stationary background. The virtual images are produced by the projection system for producing virtual images, and the moving or stationary background is produced by rear projection. An especially realistic presentation is obtained when, as illustrated in FIG. 5B, a real person or a real object 212 is located in front of the film 22 and behind the virtual image 210. As an alternative to the arrangement according to FIG. 5B, the person 212 may also step out of the virtual image, as illustrated in FIG. 5A.

If, as in the present embodiment, the projection is performed through a film that is transparent only in the direction of projection space 1, then the projection systems are invisible to the observer. Use of films that are transparent in only one direction is advantageous for this invention, but is by no means obligatory.

With the variants illustrated in FIGS. 5A and 5B, a practically perfect three-dimensional illusion is achieved in particular when the movements of the real presentation or object are coordinated with the projected image or movie, e.g., with the help of a suitable control device.

In addition to controlling or coordinating the movements on the stage with those of the image, it is also possible for the movements of the person or the object to be recorded and therefore the image movements in the film can be coordinated exactly with the movements on the stage through an appropriate [means]. This can be performed, for example, with the help of the moving belt according to this invention or with light barriers and laser projection systems. It is especially advantageous if the size of the projected object correlates with that of the real presenter or object.

FIG. 6A shows a second embodiment of a projection system. The projection system 400 for producing virtual images is arranged in the area of a projection space or stage 402, namely above the stage space. The system is again designed as a system for producing virtual images. The rear projection system 406 is located behind the stage space and projects an image onto the rear projection wall 408. A presenter 410 moves in front of the image projected from the rear onto the rear projection wall 408.

In the embodiment illustrated in FIG. 6A, it is crucial that both the front projection system 400 and the rear projection system 406 are arranged only in the area of the stage space 402 or behind it, i.e., there are no projection systems in the viewer space 412.

The viewer space 412 may be separated from the projection space by means of a stage curtain 414, for example.

The light emitted by the projection system for producing virtual images, arranged above the projection space 402 in the embodiment illustrated here, passes through a film 416 into the stage space. The film 416 is advantageously designed so that it is transparent only in the direction of projection space 402, so that the projection system remains invisible from the viewer space 412.

The light of the projection for producing virtual images strikes the means for producing a virtual image 418 which is inclined at an angle of 45° to the horizontal in position 418.1, so that a virtual image of the image projected by the projection device for producing virtual images is formed behind the glass panel 418 and in front of the rear projection surface 408. The glass panel may advantageously be arranged in different positions, positions 418.2 and 418.3 being the ones shown here, and this achieves the result that the virtual image is slowly removed out of the projection space. Conversely, it is also possible to create a virtual image in the projection space in the case of a horizontal position of the glass panel by pivoting it into position 418.1. With this technique, various virtual images can be projected into the stage space unnoticed by the observer and then made to disappear again. In the present example, in position 418.1, the virtual image is produced in the stage space at the location labeled as 420. The real person 412 in the embodiment illustrated here is located between the virtual image 420 and the rear projection surface 408. The real person 412 can step out of the image in the case of a projected virtual image 420 by moving from the rear part of the projection space into the front part. No change in projection or movement of projection surfaces is necessary for this purpose.

FIG. 6B shows the projection system according to FIG. 6A in a front view. For the same parts as shown in FIG. 6A, the same reference numbers are used in FIG. 6B. FIG. 6B shows clearly the rotating disk 600 countersunk in the stage floor 526 with the moving belt 520. In the embodiment according to FIG. 6A or 6B, the plane of the virtual image is in the area of the rotating disk with moving belt 600. Depending on the movement of the presenter on the moving belt, e.g., in the direction 602 shown here, the speed of the moving belt is increased or decreased. Likewise, the movement of the presenter from the center of the moving belt 520 to the right or left side is sensed and the disk is moved according to arrow 604 accordingly. In addition to sensing the movement of the presenter and the control of the moving belt or the rotating disk according to this movement, it is also possible to regulate the disk or the moving belt as a function of the virtual images projected by the projection device. In this way, it would be possible to move a three-dimensional object, for example, which is brought onto the moving belt, e.g., an automobile, as a function of the projected images, e.g., to have it come out of the virtual image into the stage area or have it disappear behind the projected images. For example, three-dimensional objects may be synchronized completely in their movement with the movement of the projected image, so that a practically three-dimensional presentation is created for the observer.

FIG. 6C shows again a detailed view along section D-D of the rotating disk according to this invention. The recess 606 in the stage floor 526 and the rails 502 on which the rotating disk is moved in the stage floor with the help of running wheels 504.1, 504.3 can be seen here clearly. The drive of the running wheels may be provided by electric motor 508, for example. The moving belt 520 passes around the driving roller 530 and the tension roller 532.

FIG. 7 shows a detail of one possible structural embodiment of a pivotable device for producing virtual images in a stage area. The means for producing virtual images 418, which in the present case may include a frame with a film, are pivotably guided at two points 430, 432 with the help of a plate 434, each comprising a total of four rollers 438, in a horizontal rail 436 as well as a vertical rail 440. If the frame or the glass panel 418 is moved out of the 45° position 418.1 into position 418.3, for example, the panel which is guided on the vertical rail is pulled upward by means of a cable 444 driven by an electric motor 442 and is moved into the proper position.

Electric motor 442 may be connected to a controller that can control the means for producing virtual images 418 according to a predetermined sequence or program.

FIGS. 8A through 8D illustrate in greater detail the embodiment of the means for producing virtual images with the help of a transparent film including a frame.

FIG. 8A shows the film 452, which is clamped in a frame 415 and inclined at an angle of 45° to the horizontal in the embodiments illustrated in FIG. 8A. The anchoring of the film 452 in the frame 415 is shown in greater detail in FIG. 8B. Frame 415 consists of a triangle at whose corner points 454.1, 454.2 and 454.3 connecting elements are provided. Two threaded rods 456.1, 456.2 are passed through the connecting element 454.3, and they in turn hold a clamping device 458. The clamping device 458 includes two clamping plates 460 with a clamping screw 462. By tightening the clamping screw 462, the rod 464, which is in turn connected to the film 452, is secured. In this manner, the film 452 can be clamped securely so that it is taut. Another advantage of such an arrangement is that the film can be replaced easily in the event of wear or damage by releasing the individual clamp connection element along the frame 450. The clamping device 458 for clamping the film is shown again in greater detail in FIGS. 8C and 8D.

The clamping plate 480, which is secured to the frame by means of threaded rods 456.1, 456.2, can be seen clearly in FIG. 8C. The film 452, which surrounds a round rod 464 and the tension screws 462, can also be seen clearly. FIG. 8D shows the clamping device 458 in a sectional view. This also shows clearly the upper and lower clamping plate 460, and the film wrapping around the round rod 464 and glued to itself at two gluing points 466.1 and 466.2, so that it cannot slide out of the round rod under tension.

FIG. 9 shows an advancement on this invention in which several projection systems are provided for producing virtual images, namely in the present case two projection systems for producing virtual images 400.1, 400.2.

A transparent film 416.1 and means for producing virtual images 418.A are provided with the respective projection system for producing virtual images 400.1, or for producing virtual images 400.2, 418.B in the case of the projection system.

Both projection systems for producing virtual images 400.1, 400.2 are provided in the area of the stage or in the projection space above the stage.

The projection system 400.1 is deflected by means of a mirror 470 onto the means for producing virtual images. The mirror 470 is mounted so it can pivot about the angle γ on a crossbar 472, as illustrated in FIG. 9B.

Through appropriate adjustment of the mirror 470, the projection system can be adjusted according to specifications, e.g., if film 416.1 begins to sag.

The virtual image of the projection system 400.1 is produced at point 420.1. The projection system 400.2 produces a virtual image at point 420.2. The system according to FIG. 9A allows the projection of different landscapes or images against which an actor can act by turning the respective front projection systems 400.1 and 400.2 for producing the corresponding virtual images on and off. This is done completely without being noticed by the observer and without having to move any screens.

FIG. 10 shows a side view of a projection system according to FIG. 6. Again the stage space 402 and the guides 490, 492 for shifting the screen 408 in the direction of arrows 474, 476 in the plane of the stage can be seen clearly. In an especially advantageous embodiment of this invention, it is proposed that not only should the rear projection screen 474, 476 be shifted, but instead the projector 406 for rear projection should also be shifted together with the screen 408, which is movable in the direction of arrows 474, 476. A motor 494 with a worm gear drive may be used as the drive for moving the screen and the projector 406; with the help of a chain 496, the motor moves the projection surface 408, which is clamped in a frame.

It is especially advantageous if motors 494 for moving the rear wall are arranged on both sides of the stage 402 or the projection space, as illustrated in FIG. 10C. Due to the movement of the rear projection wall 408 according to this invention jointly with the rear projection system 406 by coupling the rear wall 408 and the projector 406 together and keeping the distance between the projector 406 and the rear wall 408 constant, it is not necessary to alter the focus of the projector when moving the rear wall 408. This system makes it readily possible to increase or decrease the size of the holographic space in a simple manner by moving the rear projection wall 408. This permits a smooth variation in depth. In addition, it is also possible with such an arrangement that, when the rear projection wall 408 is brought into the position in which the virtual image 420 is produced by the projection system for producing virtual images, the rear projection receives the virtual image without a viewer in the viewer space 412 being able to notice any spatial change.

Except for the movability of the rear projection wall 408 together with the projector 406, the system according to FIGS. 10A through 10C is like the system according to FIG. 6, for example. Therefore, the same reference numbers are used for the same parts as in FIG. 6.

The displacement of rear projection wall 408 combined with the projector 406 takes place as described above and as illustrated in FIG. 10C essentially along two parallel rails 490, 492.

The device according to this invention permits a perfect three-dimensional representation of actions in a film to be shown against a projected background, for example, in combination with a projection system. Thus, this system can be used as a portable studio, for example.

With the help of this invention, it is thus possible for the first time to combine or coordinate a spatial relationship between the projected film or image and an object in the projection space or a person acting there in such a way that it is no longer possible for the observer to distinguish the difference between the projected movement and the movement taking place on the stage.

1. A device for moving 3-dimensional objects in the projection space of a projection system, having
1.1 a rotating disk,
1.2 a moving belt countersunk in the rotating disk, characterized in that
1.3 the rotating disk and/or the moving belt has sensors for detecting the movement of the object on the rotating disk or the moving belt, and
1.4 the moving belt and/or the rotating disk is driven or regulated with the help of a control/regulating device as a function of the detected movement of the object.

2. The device according to claim 1, characterized in that the 3-dimensional object is a person acting on the stage.

3. The device according to one of claims 1 or 2, characterized in that the moving belt and/or the rotating disk has supporting rollers on which sensors are arranged.

4. The device according to one of claims 1 through 3, characterized in that the sensors detect the weight that changes with movement of the object or the person.

5. The device according to one of claims 1 through 4, characterized in that the moving belt comprises a driving roller and a tension roller.

6. The device according to claim 5, characterized in that the control and/or regulating device controls the moving belt in such a way that when the person moves in the direction of the driving roller, the speed of the moving belt is increased.

7. The device according to claim 5 or 6, characterized in that the control and/or regulating device controls the moving belt in such a way that when the person moves in the direction of the tension roller, the speed of the moving belt is decreased.

8. The device according to one of claims 5 through 7, characterized in that the control and/or regulating device drives the rotating disk in such a way that when the person moves out of the center of the moving belt, the rotating disk moves in the opposite direction.

9. A system for presentation of live shows which are combined with and/or superimposed on projected images and/or movies, having
9.1 a projection space;
9.2 at least two projection systems, a first and a second projection system;
9.3 at least one projection surface which can be introduced into the projection space and removed from it, or is arranged in a stationary mount in the projection space, whereby
9.4 the first projection system is a projection system for producing virtual images, and the second projection system is a rear projection system, characterized in that
9.5 the system comprises a device for moving 3-dimensional objects according to one of claims 1 through 8.

10. The system according to claim 9, characterized in that the control/regulating device of the rotating disk and/or the moving belt is linked to the control/regulating device for the projection system.

11. The system according to claim 10, characterized in that the control/regulating device on the projection system is arranged downstream from the control/regulating device of the moving belt and/or the rotating disk and the images are projected by the projection system as a function of the movement of the person.

12. The system according to one of claims 10 through 11, characterized in that the system comprises means for producing a virtual image in the projection frame in front of a projection surface.

13. The system according to claim 12, characterized in that the device for producing the virtual image is glass or at least a partially transparent film.

14. The system according to claim 13, characterized in that the glass or the film, which is at least partially transparent, is electro-optically or thermo-optically active.

15. The system according to one of claims 10 through 14, characterized in that the means for producing a virtual image are mounted pivotably in the projection space so that any desired angles to the horizontal in the range of 0≦α<90° can be set.

16. The system according to claim 15, characterized in that the mounting of the means for producing a virtual image includes rails.

17. The system according to one of claims 9 through 16, characterized in that the projection surfaces for the rear projection can be moved smoothly in the projection space in combination with the respective rear projection system(s), so that the focus need not be altered.
